(19) United States
(12) Patent Application Publication
(10) Pub. No.: US 2025/0113806 A1
(43) Pub. Date: Apr. 10, 2025

(54) AN UNDERWATER SENSOR, AND A METHOD FOR ADJUSTING TOWING POWER OF A VESSEL

(71) Applicant: SCANTROL DEEP VISION AS, Bergen (NO)

(72) Inventors: Helge HAMMERSLAND, Arnatveit (NO); Kristoffer LØVALL, Bergen (NO)

(21) Appl. No.: 18/832,411

(22) PCT Filed: Jan. 17, 2023
(86) PCT No.: PCT/NO2023/050010

§ 371 Date: Jul. 23, 2024

(30) Foreign Application Priority Data
Feb. 8, 2022 (NO) 20220175

(51) Int. Cl. A01K 61/95; A01K 73/10; G01S 15/96; G06T 7/285; G06V 20/05; G06V 20/56; G06V 20/64; H04N 13/239; H04N 13/254; H04N 13/296

(52) U.S. Cl. CPC A01K 61/95; A01K 73/10; G01S 15/96; G06T 7/285; G06V 20/05; G06V 20/56; G06V 20/647; H04N 13/239; H04N 13/254; H04N 13/296; G06T 2207/10021; G06T 2207/30242

(57) ABSTRACT

An underwater sensor (10) comprising several cameras (14) that take pictures of fish (70) to identify species and measure size, with a sensor housing (12) which can be placed in a trawl (50), where the sensor housing (12) comprises: at least two cameras (14) in stereo configuration arranged to take pictures of passing fish, one or 5 more light modules (16) to illuminate passing fish, a sonar (18) arranged to register passing fish, a control and processing unit (22) connected to said cameras (14), light modules (16) and sonar (18), as well as a battery (20). The control and processing unit (22) is on a signal from the sonar (18) arranged to activate or deactivate said cameras (14) and light modules (16), as well as to process said images to identify 0 the species and measure the size of passing fish.

### FIELD OF THE INVENTION

The present invention relates to an underwater sensor comprising one or more cameras which, during use in a trawl, take pictures of fish to identify species and measure size. The invention further relates to a method for adjusting towing power of a vessel.

### BACKGROUND OF THE INVENTION

In connection with trawling for marine organisms such as fish, it is desirable both for commercial fishing or in connection with marine surveys to be able to sort fish by size and species, as well as to be able to calculate the biomass of the fish in the trawl.

Fish that are the wrong size or of the wrong species can be released from the trawl after identification.

To conduct efficient trawling operations, it is essential to use the correct towing power. When the towing power of the vessel is too low, fish will swim out of the trawl, resulting in low catching efficiency. Too high towing power will result in excessive fuel consumption.

### DISCUSSION OF PRIOR ART

NO325882 B1 shows a method and system for automatic classification of fish comprising a camera system arranged to take pictures of the passing fish, and an analysis unit set to receive and to analyse each picture for classifying the fish. The species and size of the fish are determined using image processing, and the system is intended to be used onboard marine research vessels and commercial fishing boats. Also described is that fish based on the analysis can be released from the trawl.

Furthermore, EP2750497 B1 shows a system and a method for sorting fish during fishing, where a monitoring unit in the inflow area of the trawl is used to register fish and to control the opening and closing of a trawl bag so that fish flow into or out of the trawl bag.

Reference is also made to EP 3754374 A1 which describes the use of a stereo camera combined with sonar. However, the sonar is not used to activate the camera.

Battery operation is also not described. WO 2017204660 A1 describes the use of a stereo camera. US2011292201 A1 describes an underwater monitoring system where a sonar is used to trigger a camera. GB 2139366 A describes a system where a sonar is used to trigger a film-based camera.

### OBJECTS OF THE PRESENT INVENTION

The underwater sensor according to the invention is intended to be mounted in a trawl to register fish that pass the underwater sensor inside the trawl.

The underwater sensor is powered by a rechargeable and replaceable battery which usually has a capacity of up to 100 Wh. This is a practical limitation due to physical size and rules for the transport of dangerous goods. As image taking, light and image processing require a relatively large amount of energy, this battery size will set limits in terms of the capacity to have continuous image processing through an entire trawl haul.

An object of the invention is to produce an underwater sensor with reduced energy consumption, and which ensures enough battery capacity to have continuous image processing through an entire trawl haul.

It is therefore an object to produce an underwater sensor which is activated when there are fish in the field of vision and is deactivated when there are no fish in the field of vision.

Challenges with the development of the underwater sensor according to the invention are to achieve reduced size, reduced costs, energy consumption, communication with the vessel and environmental impacts.

It is further an object to provide a method for adjusting towing power of a vessel based on detecting fish movement in the trawl.

### SUMMARY OF THE INVENTION

The above-mentioned objects are achieved with an underwater sensor for use in a trawl and with several cameras that take pictures of fish to identify species and measure size. The underwater sensor comprises a sensor housing which can be placed in a trawl, where the sensor housing comprises: at least two cameras in stereo configuration, arranged to take pictures of passing fish; one or more light modules to illuminate passing fish; a sonar arranged to register passing fish; a control and processing unit connected to said cameras, light modules and sonar; as well as a battery, as the control and processing unit is designed to activate or deactivate said cameras and light modules on a signal from the sonar, as well as to process said images to identify the species and measure the size of passing fish.

The sensor housing can further comprise fastening means for attachment to a net wall in a trawl bag of the trawl. Said fastening means for fastening the underwater sensor can comprise several fastening ears and shackles.

The sonar preferably mainly has the same field of view as said cameras.

When registering fish within its field of vision, the sonar is arranged to send a signal to the control and processing unit about activation of said cameras and light modules.

In the event of a failure to register fish within its field of vision, the sonar is further arranged to send a signal to the control and processing unit about deactivation of said cameras and light modules.

The underwater sensor can comprise an acoustic link arranged to send data signals to a vessel.

Said light modules in the underwater sensor are preferably LED lights.

The sonar can be arranged to record biomass of passing fish. The control and processing unit can thus, based on collected image data from the cameras and recorded biomass from the sonar, be arranged to estimate the total amount of fish in the trawl.

The battery which is used in the underwater sensor is preferably a rechargeable battery with a capacity of up to 100 Wh.

The above-mentioned objects are achieved with a method for adjusting towing power of a vessel based on detecting fish movement in a trawl, said trawl being hauled by a vessel having towing power, wherein the trawl comprises an underwater sensor as disclosed. The method comprises the steps of:
using at least one camera to track fish over a sequence of images,
applying a tracking algorithm to calculate the speed and direction of the fish relative to the trawl,
transmitting the result of the calculations to the vessel to determine whether the vessel's towing power is correct, and
adjusting the towing power, if the towing power is too low or too high.

The fish are tracked to detect if they are entering into the trawl or swimming out of the trawl.

Signals can be sent acoustically from the underwater sensor to the acoustic receiver and transmitter onboard the vessel.

### DESCRIPTION OF FIGURES

Preferred embodiments of the invention will be described in more detail below with reference to the accompanying figures, in which:

FIG. 1 shows a trawl system with the present invention.

FIG. 2 shows an underwater sensor according to the present invention

FIG. 3 shows a block diagram of the underwater sensor according to the present invention.

FIG. 4 shows a trawl being hauled by the vessel, and relative movement of the fish in view of the trawl.

### DESCRIPTION OF PREFERRED EMBODIMENTS OF THE INVENTION

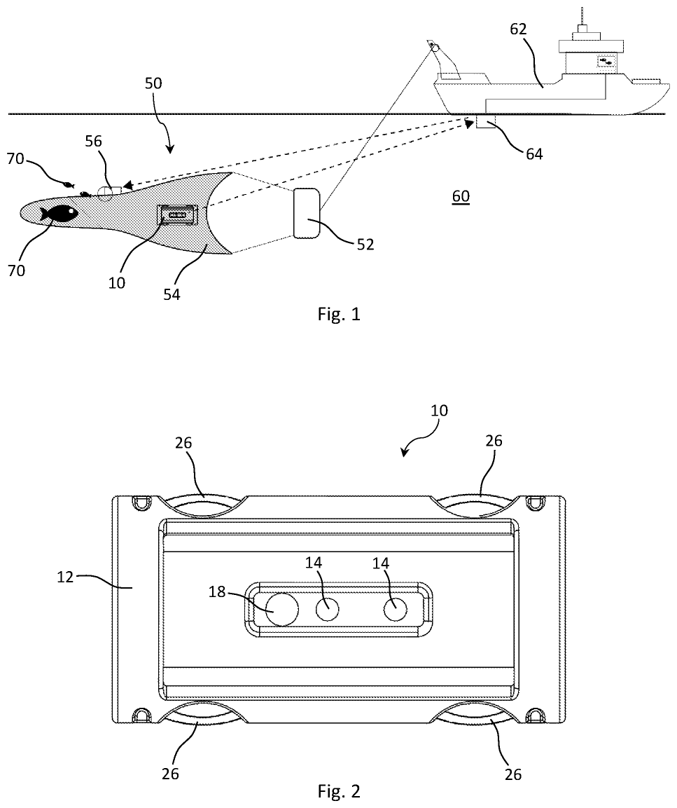

FIG. 1 shows a trawl system with the present invention where a vessel 62 tows a trawl 50 in a body of water 60. The trawl 50 comprises, in a known manner, trawl doors 52 to control the trawl in the water and to adjust the opening of the trawl, as well as one or more trawl bags 54.

The trawl bag 54 preferably includes a selection mechanism 56 which, on signal, can open for discharge of unwanted fish. Unwanted fish can, for example, be fish of the wrong species, fish that are too small or fish that are not legal to catch. The selection mechanism 56 can be activated based on processing in an underwater sensor 10 which is placeable on a net wall of the trawl 50, for example, on the net wall of a trawl bag 54, in which the species and size of fish are determined, or the selection mechanism 56 can be activated based on individual decisions onboard the vessel 62. Signals can be sent acoustically from the underwater sensor 10 to an acoustic receiver and transmitter 64 onboard the vessel 62, whereupon signals can further be sent acoustically to the selection mechanism 56. Data signals from the underwater sensor 10 can also be processed onboard the vessel 62 before signals are sent to the selection mechanism 56. The dotted lines in FIG. 1 show the signal path as explained.

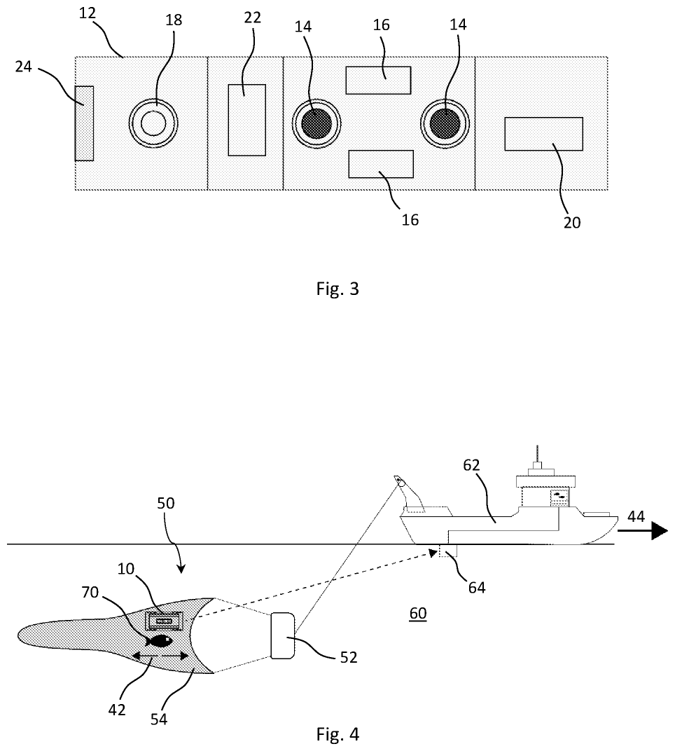

FIGS. 2 and 3 show the underwater sensor 10 according to the invention in more detail. The underwater sensor 10 is a camera-based sensor that takes stereo images of fish in order to register fish that pass the sensor inside the trawl 50 and which identifies species and measures size, where the underwater sensor comprises a sensor housing 12 equipped with fastening means in the form of, for example, fastening ears 26 which, by means of shackles (not shown) or similar are used to attach the sensor housing 12 to the trawl bag 54.

The sensor housing 12 of the underwater sensor 10 is equipped with at least two cameras 14 in stereo configuration which take still images of the fish passing by. As shown, the two cameras 14 are mounted side by side, with a relatively short distance between them. Adjacent to the cameras 14, one or more LED light modules 16 (FIG. 3) with high intensity are built in, which are activated when pictures of the fish are to be taken. The cameras 14 and the light modules 16 are connected to a computer in the form of a control and processing unit 22 which controls the image taking and which processes the images to identify the species and measure the size of the fish in the image. The control and processing unit 22 calculates the species and size distribution of fish which is registered in a certain period of time and sends this information to the vessel 62 via an acoustic link 24 to the acoustic receiver and transmitter 64 onboard the vessel 62. Onboard the vessel 62 the acoustic signals are decoded, and an overview of species and size distribution is presented on a screen on the bridge.

The sensor housing 12 of the underwater sensor 10 is further comprising a sonar 18 located mainly adjacent to the cameras 14 so that the sonar 18 has the same field of view. When the sonar 18 registers fish 70, a signal is sent to the control and processing unit 22 which then activates the cameras 14 and the light modules 16. Conversely, when no fish 70 are registered, the cameras 14 and the light modules 16 are deactivated.

FIGS. 2 and 3 show that two cameras 14 and one sonar 18 are placed next to each other. It is conceivable that in the sensor housing 12 several pairs of cameras 14 and adjacent sonars 18 are placed.

The underwater sensor 10 is powered by a rechargeable battery with a capacity of for instance up to 100 Wh. This is a practical limitation due to physical size and rules for shipping dangerous goods. As image taking, light and image processing require a relatively large amount of energy, this battery size will not have enough capacity to have continuous image processing through an entire trawl haul. The present invention includes a sonar 18 which has the same field of view as the cameras 14, and which is used to activate the underwater sensor 10 when there are fish in the field of view and deactivate it when there are no fish in the field of view. The sonar 18 can also be used to register biomass and the control and processing unit 22 can use this information together with image data to estimate the total amount of fish in the trawl. Since the sonar 18 is low in energy, this solution will make it possible to carry out a full trawl haul with said battery capacity.

Operating conditions for an underwater sensor according to the invention can, for example, be that the maximum battery capacity shall be 100 Wh and with an operating time of at least 8 h to maintain a full trawl haul. Energy consumption at full capacity (10 f/s) should not exceed 30 W. These operating conditions are achieved with an underwater sensor 10 according to the present invention.

The camera(s) 14 of the underwater sensor 10 can, in addition to taking pictures of fish to identify species and measuring size, also be used to track fish 70 to detect if the fishes are entering into the trawl 50 or swimming out of the trawl 50. Fish motion is detected by tracking fish 70 over a sequence of images, and a tracking algorithm calculates the speed and direction of the fish 70 relative to the trawl. The speed and direction of the fish 70 is indicated by the arrows and reference number 42 in FIG. 4. The result of this calculation is transmitted by acoustics (or cable) to the vessel 62 so that the skipper can determine whether the vessel's towing power is correct. The vessel's towing power is indicated by the arrow and reference number 44 in FIG. 4. Signals can be sent acoustically from the underwater sensor 10 to the acoustic receiver and transmitter 64 onboard the vessel 62. To conduct efficient trawling operations, it is essential to use the correct towing power. When the towing power of the vessel is too low, fish will swim out of the trawl, resulting in low catching efficiency. Too high towing power will result in excessive fuel consumption.

1. An underwater sensor (10) comprising several cameras (14) that take pictures of fish (70) to identify species and measure size, characterised by
a sensor housing (12) which can be placed in a trawl (50), where the sensor housing (12) comprises:
at least two cameras (14) in stereo configuration arranged to take pictures of passing fish,
one or more light modules (16) to illuminate passing fish,
a sonar (18) arranged to register passing fish,
a control and processing unit (22) connected to said cameras (14),
light modules (16) and sonar (18), and
a battery (20),
wherein the control and processing unit (22) on a signal from the sonar (18) is arranged to activate or deactivate said cameras (14) and light modules (16), and to process said images to identify the species and measure the size of passing fish.

2. The underwater sensor (10) in accordance with claim 1, characterised in that the sensor housing (12) comprises fastening means (26) for attachment to a net wall in a trawl bag (54) of the trawl (50).

3. The underwater sensor (10) in accordance with claim 2, characterised in that said fastening means (26) for fastening the underwater sensor (10) comprises several fastening ears and shackles.

4. The underwater sensor (10) in accordance with claim 1, characterised in that the sonar (18) has mainly the same field of view as said cameras (14).

5. The underwater sensor (10) in accordance with claim 1, characterised in that the sonar (18) when registering fish within its field of view is arranged to send a signal to the control and processing unit (22) about activation of said cameras (14) and light modules (16).

6. The underwater sensor (10) in accordance with claim 1, characterised in that the sonar (18) is arranged to send a signal to the control and processing unit (22) about the deactivation of said cameras (14) and light modules (16).

7. The underwater sensor (10) in accordance with claim 1, characterised in that the underwater sensor (10) comprises an acoustic link (24) arranged to send data signals to a vessel (62).

8. The underwater sensor (10) in accordance with claim 1, characterised in that said light modules (16) are LED lights.

9. The underwater sensor (10) in accordance with claim 1, characterised in that the sonar (18) is arranged to record biomass of passing fish.

10. The underwater sensor (10) in accordance with claim 9, characterised in that the control and processing unit (22) based on collected image data from the cameras (14) and registered biomass from the sonar (18) is designed to estimate the total amount of fish in the trawl (54).

11. The underwater sensor (10) in accordance with claim 1, characterised in that the battery (20) is a rechargeable battery with a capacity of up to 100 Wh.

12. A method for adjusting towing power (44) of a vessel (62) based on detecting fish (70) movement in a trawl (50), said trawl (50) being hauled by a vessel (62) having towing power (44), wherein the trawl (50) comprises an underwater sensor (10) according to claim 1, said method comprises the steps of:
using at least one camera (14) to track fish (70) over a sequence of images,
applying a tracking algorithm to calculate the speed and direction of the fish (70) relative to the trawl (50),
transmitting the result of the calculations to the vessel (62) to determine whether the vessel's towing power (44) is correct, and
adjusting the towing power (44), if the towing power (44) is too low or too high.

13. The method according to claim 12, wherein fish (70) are tracked to detect if they are entering into the trawl (50) or swimming out of the trawl (50).

14. The method according to claim 12, wherein signals are sent acoustically from the underwater sensor (10) to the acoustic receiver and transmitter (64) onboard the vessel (62).
